(19) United States
(12) Patent Application Publication
(10) Pub. No.: US 2006/0132911 A1
(43) Pub. Date: Jun. 22, 2006

(54) Transmission type screen and rear projection display

(75) Inventors: Yasufumi Ogawa, Chiba (JP); Takaaki Iwaki, Tokyo (JP); Hiroaki Uchino, Tokyo (JP); Satoru Murata, Kanagawa (JP); Minoru Makida, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/300,903

(22) Filed: Dec. 15, 2005

(30) Foreign Application Priority Data
Dec. 16, 2004 (JP) 2004-364802

(51) Int. Cl. G03B 21/60

(52) U.S. Cl. 359/457

(57) ABSTRACT

In a transmission type screen structured to have at least two layers, namely, a first layer having a lenticular lens and having black stripes on the viewer's side relative to the lenticular lens and a second layer adjacent to the first layer, which are disposed sequentially as viewed from the viewer's side, the focal distance of the lenticular lens of the first layer is so set that external light having been skewly incident from the viewer's side and having passed through the gaps between the black stripes of the first layer is reflected on the lens surface of the lenticular lens of the first layer to impinge on the black stripes, whereby the “waviness” due to the light reflected by the second layer can be suppressed more effectively.

### CROSS-REFERENCES TO RELATED APPLICATIONS

The present invention contains subject matter related to Japanese Patent Application 2004-364802 filed with the Japanese Patent Office on Dec. 16, 2004, the entire contents of which being incorporated herein by reference.

### BACKGROUND OF THE INVENTION

The present invention relates to a transmission type screen for a rear projection type display system and to the rear projection type display system.

As a kind of large-screen picture display system, rear projection type display systems (rear projection displays) are wide spread. The rear projection display, as well known, is a system in which video light emitted from a video light source, for example, a CRT, an LCD device, a DLP (Digital Light Processing) device or the like is reflected and enlarged by a mirror, is then projected on a transmission type screen from the rear side, and the projected picture is viewed from the front side of the transmission type screen.

In the rear projection display, generally, the angle of incidence of the light from the mirror on the transmission type screen is set steep for the purpose of reducing the size of the optical system (shortening the optical path length). Therefore, the transmission type screen is provided with a Fresnel lens for converting the video light from the mirror into parallel beams (converting into beams perpendicular to the screen surface).

Furthermore, the transmission type screen is provided with a lenticular lens sheet (having black stripes in regions where the video light does not pass through) for deflecting the video light converted into the parallel beams by the Fresnel lens, for the purpose of enlarging the angle of visibility.

In the transmission type screens for rear projection displays which have been put to practical use, only a horizontal lenticular lens sheet for polarizing the video light in a horizontal direction (enlarging the angle of visibility in a horizontal direction) is provided as the lenticular lens sheet, to constitute a two-layer structure having one Fresnel lens sheet and one lenticular lens sheet (on a reference basis, a transmission type screen of a three-layer structure in which a vertical lenticular lens sheet for polarizing the video light in the vertical direction is further provided on the viewer's side relative to the horizontal lenticular lens sheet has also been proposed (see, for example, Japanese Patent Laid-open No. Hei 8-101459 (paragraph No. 0021 to 0022, FIG. 1))).

### SUMMARY OF THE INVENTION

Meanwhile, one of the phenomena leading to a lowering in the picture quality in a rear projection display is the phenomenon called “waviness” generated when external light, such as light from a fluorescent lamp, is skewly incident on the transmission type screen from the viewer's side. This is a phenomenon in which, where a layer (the second or latter layer) on the inner side relative to the layer (the first layer) facing the viewer's side is deflected, the quantity of reflected light at the time when the external light incident on the screen is reflected on the surface of the inner-side layer varies depending on position, resulting in that, when the reflected light is again emitted from the screen to the viewer's side, display irregularities such as a Newton ring-like fringe appear on the screen.

Particularly, the “waviness” due to the reflected light reflected between portions of the second layer directly on the inner side of the first layer is conspicuous, imposing a problem. In view of this, the principle of generation of the “waviness” by the reflected light reflected between portions of the second layer will be described referring to FIGS. 5 and 6.

As shown in FIG. 5, a portion of the external light L2 skewly incident on the first layer 31 from the viewer's side is not intercepted by the black stripes 31-1 but passes through a gap between the black stripes 31-1. When the passed light is emitted from the lenticular lens 31-2 of the first layer 31 to the side of the second layer 32, a portion of the thus emitted light is reflected by the surface of the second layer 32, and is again emitted through the first layer 31 to the viewer's side.

The quantity of the light reflected on the surface of the second layer 32 is determined by the shape of the lenticular lens 31-2 of the first layer 31 and the spacing between the first layer 31 and the second layer 32. In the case where a resin-made substrate is used as the second layer 32, deflection of the second layer 32 results in that the spacing between the first layer 31 and the second layer 32 varies depending on position. By taking a transmission type screen of the three-layer structure described in the above-mentioned patent reference as an example, FIG. 6 shows the condition where the second layer 32 (in the patent reference, the horizontal lenticular sheet) disposed between the first layer 31 (in the patent reference, the vertical lenticular lens sheet) and the third layer 33 (in the patent reference, the Fresnel lens sheet) has been deflected, with the result that the spacing between the first layer 31 and the second layer 32 varies depending on position (T≠T′).

Where the spacing between the first layer 31 and the second layer 32 varies depending on position in this manner, the quantity of light reflected on the surface of the second layer 32 varies depending on position, so that the quantity of light emitted to the viewer's side also varies depending on position. This causes display irregularities to appear on the screen.

Here, there may be contemplated, for example, a method in which an anti-glare sheet is adhered to the surface of the second layer 32 so as to reduce the quantity of the light reflected on the surface of the second layer 32 to again enter the first layer 31. However, this method alone has a limit in the suppressing effect on the “waviness”.

Thus, there is a need to more effectively suppress the “waviness” due to the light reflected on the second layer in a transmission type screen having two or more layers.

In order to fill the above need, according to an embodiment of the present invention, there is provided a transmission type screen including, at least: a first layer having a lenticular lens and having black stripes on the viewer's side relative to the lenticular lenses; and a second layer adjacent to the first layer, the two layers being disposed sequentially as viewed from the viewer's side, wherein the focal distance of the lenticular lens of the first layer is so set that external light having been skewly incident from the viewer's side and having passed through the gaps between the black stripes of the first layer is reflected on the surface of the lenticular lens of the first layer to impinge on the black stripes.

The transmission type screen is a transmission type screen of a structure having at least two layers, wherein the focal distance of the lenticular lens of the first layer is so set that external light having been skewly incident from the viewer's side and having passed through the gaps between the black stripes of the first layer is reflected on the surface of the lenticular lens of the first layer to impinge on the black stripes.

Therefore, the external light having passed through the gaps between the black stripes of the first layer again returns to the black stripes so as to be intercepted thereby (namely, the light does not outgo from the first layer to the second layer side).

Thus, according to the transmission type screen, it is possible to reduce the quantity itself of that portion of the external light having been skewly incident from the viewer's side which passes through the first layer and outgoes to the second layer side. This makes it possible to effectively suppress the “waviness” due to the light reflected on the second layer.

Incidentally, as one example, the transmission type screen may have a configuration in which the second layer has a lenticular lens in a direction perpendicular to that of the first layer and has black stripes on the viewer's side relative to the lenticular lens, and a third layer having a Fresnel lens is further disposed on the side of the second layer opposite to the viewer's side (namely, a transmission type screen of a three-layer structure in which one of the lenticular lenses of the first and second layers corresponds to a horizontal lenticular lens, and the other corresponds to a vertical lenticular lens).

In the transmission type screen of such a three-layer structure, also, the focal distance of the lenticular lens of the first layer is set as above-mentioned (in other words, the focal distance of one of the horizontal lenticular lens and the vertical lenticular lens is set as above-mentioned, and the shapes and positional relationship of the horizontal lenticular lens and the vertical lenticular lens are so investigated that the lenticular lens with the thus set focal distance serves as the first layer), whereby it is again possible to effectively suppress the “waviness” due to the light reflected by the second layer.

Besides, in the transmission type screen having the three-layer structure, as one example, it is preferable that the first layer has the horizontal lenticular lens, and the second layer has the vertical lenticular lens (namely, the horizontal lenticular lens is arranged in the first layer, and the focal distance thereof is set as above-mentioned).

To ensure that the external light having passed through the gaps between the black stripes is reflected by the surface of the lenticular lens to impinge on the black stripes, it is desirable to set the focal distance of the lenticular lens to a somewhat short distance. In addition, the lenticular lens has a greater enlarging effect on the angle of visibility as its focal distance is shorter. Besides, in comparing the horizontal lenticular lens with the vertical lenticular lens, there are not many cases where the screen is viewed from the skew upper side or skew lower side, whereas there are many cases where the screen is viewed from the skew left or right side or where the screen is viewed by a plurality of persons seated or standing side by side in the left-right direction; therefore, the horizontal lenticular lens is desired to enlarge the angle of visibility to a greater extent, as compared with the vertical lenticular lens.

Therefore, the horizontal lenticular lens is arranged as the first layer, and its focal distance is set as above-mentioned, whereby it is possible to meet the requirement for the enlargement of the angle of visibility in the horizontal direction.

In addition, in the transmission type screen, as one example, it is preferable to subject the surface on the viewer's side of the second layer to an anti-glare treatment.

The treatment ensures that the external light having been incident from the viewer's side and having passed through the first layer (the light not reflected on the surface of the lenticular lens of the first layer) is diffusedly reflected by the surface on the viewer's side of the second layer. Therefore, the quantity of the light reflected by the surface on the viewer's side of the second layer to re-enter the first layer is reduced, so that it is possible to further suppress the “waviness” due to the light reflected on the second layer.

Besides, in the transmission type screen, as one example, it is preferable that the first layer is provided with a diffusion sheet on the viewer's side relative to the lenticular lens and the black stripes. With such a diffusion sheet provided, the angle of visibility can be enlarged more. With the diffusion sheet provided on the viewer's side relative to the lenticular lens and the black stripes, the light diffused by the diffusion sheet would not be intercepted by the black stripes of the first layer, and, therefore, it is also possible to prevent the transmittance of light from being lowered in the transmission type screen.

It is further preferable that a sheet having a diffusion layer on the surface on the viewer's side of a base sheet is used as the diffusion sheet of the first layer. This ensures that a certain distance is secured between the black stripes and the diffusion layer in the first layer. If the distance between the black stripes and the diffusion layer is too short, there arises dispersion as to the locations where the luminous flux condensed by the black stripes impinges on the particles in the diffusion layer and the locations where the impingement does not occur, whereby glaring (“scintillation”) of pictures is generated at the time of displaying bright pictures. On the other hand, where a certain distance is secured between the black stripes and the diffusion layer as above-mentioned, the “scintillation” can also be suppressed.

Besides, in the transmission type screen, as one example, it is preferable for the first layer to be provided with either of an anti-glare sheet and an anti-reflection sheet on its surface on the viewer's side. By this, mirroring in the surface of the transmission type screen can be suppressed.

In addition, where the transmission type screen is made to have a three-layer structure, as one example, it is preferable that the third layer (the layer having the Fresnel lens) is provided further with an anti-glare sheet on its surface on the side (light source side) opposite to the viewer's side. When the light emitted from the video light source in the rear projection display to be incident on the transmission type screen via a mirror is reflected on the surface of the third layer and returns to the mirror, the reflected light is again reflected by the mirror to be incident on the transmission type screen, resulting in that a ghost would be generated in the picture displayed. However, where the third layer is provided with the just-mentioned anti-glare sheet, the generation of the ghost can also be restrained.

Besides, where the transmission type screen is made to have the three-layer structure, as one example, it is preferable to use a glass as a substrate of each of the first and third layers. This ensures that the flatness of both surfaces of the transmission type screen can be kept good, so that the pictures displayed can be prevented from being distorted due to a worsening of the flatness.

In the next place, according another embodiment of the present invention, there is provided a rear projection display including a video light source for emitting video light, and a transmission type screen on which the video light is projected from the rear side, wherein the transmission type screen includes, at least: a first layer having a lenticular lens and having black stripes on the viewer's side relative to the lenticular lens; and a second layer adjacent to the first layer, the two layers being disposed sequentially as viewed from the viewer's side, and the focal distance of the lenticular lens of the first layer is so set that external light having been incident skewly from the viewer's side and having passed through gaps between the black stripes of the first layer is reflected on the surface of the lenticular lens of the first layer to impinge on the black stripes.

The rear projection display uses the transmission type screen according to the above-described embodiment of the present invention, and the “waviness” due to the light reflected on the second layer of the transmission type screen can be suppressed effectively.

According to the present invention, in a transmission type screen structured to have two or more layers, the quantity itself of that portion of external light skewly incident on the transmission type screen from the viewer's side which passes through the first layer and outgoes to the second layer side can be reduced, so that the “waviness” due to the light reflected by the second layer (the phenomenon of display irregularities generated when the external light is skewly incident from the viewer's side) can be suppressed effectively.

In addition, in a transmission type screen of the three-layer structure, by disposing a horizontal lenticular lens as the first layer, the demand for enlarging the angle of visibility in the horizontal direction can be met, while effectively suppressing the “waviness” due to the light reflected by the second layer.

Besides, by applying an anti-glare treatment to the surface on the viewer's side of the second layer, the “waviness” can be suppressed more successfully.

In addition, by providing a diffusion sheet on the viewer's side relative to the lenticular lens sheet of the first layer, it is possible to further enlarge the angle of visibility and to prevent the transmittance of light in the transmission type screen from being lowered.

Besides, by using a sheet obtained by forming a diffusion layer on the surface on the viewer's side of a base sheet as a diffusion sheet of the first layer, the “scintillation” (glaring of pictures) can be suppressed.

In addition, by providing either of an anti-glare sheet and an anti-reflection sheet on the surface on the viewer's side of the first layer, mirroring in the surface of the transmission type screen can be suppressed.

Besides, in the transmission type screen of the three-layer structure, by providing the third layer with an anti-glare sheet on its surface on the side opposite to the viewer's side, the ghost can be restrained.

In addition, in the transmission type screen of the three-layer structure, by using a glass as a substrate of each of the first and third layers, the pictures displayed can be prevented from being distorted due to a worsening of the flatness of both surfaces of the transmission type screen.

### BRIEF DESCRIPTION OF THE DRAWINGS

FIG. 1 shows generally an optical system in a rear projection display to which the present invention has been applied;

FIG. 2 shows the sectional structure of the transmission type screen shown in FIG. 1;

FIG. 3 shows the structure of a horizontal lenticular lens sheet shown in FIG. 2;

FIG. 4 shows the manner in which external light is intercepted by the horizontal lenticular lens shown in FIG. 2;

FIG. 5 shows the manner in which the external light skewly incident on the transmission screen from the viewer's side goes again to the outside; and

FIG. 6 shows a deflection of the second layer in the transmission type screen.

### DETAILED DESCRIPTION

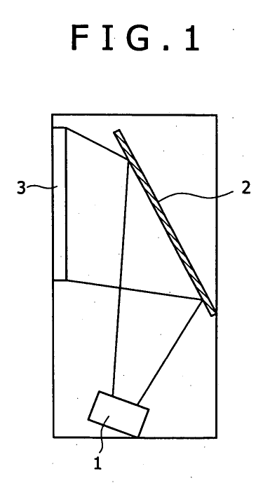

Now, the present invention will be described specifically by referring to the drawings. FIG. 1 shows generally an optical system in a rear projection display to which the present invention has been applied. A video light source 1 is composed, for example, of a CRT, an LCD device or a DLP (Digital Light Processing) device, and is driven according to video data sent from a video signal processing system (not shown), to emit video light.

The video light emitted from the video light source 1 is reflected and enlarged by a mirror 2, is then projected on a transmission type screen 3 from the rear side, and outgoes from the transmission type screen 3 to the viewer's side.

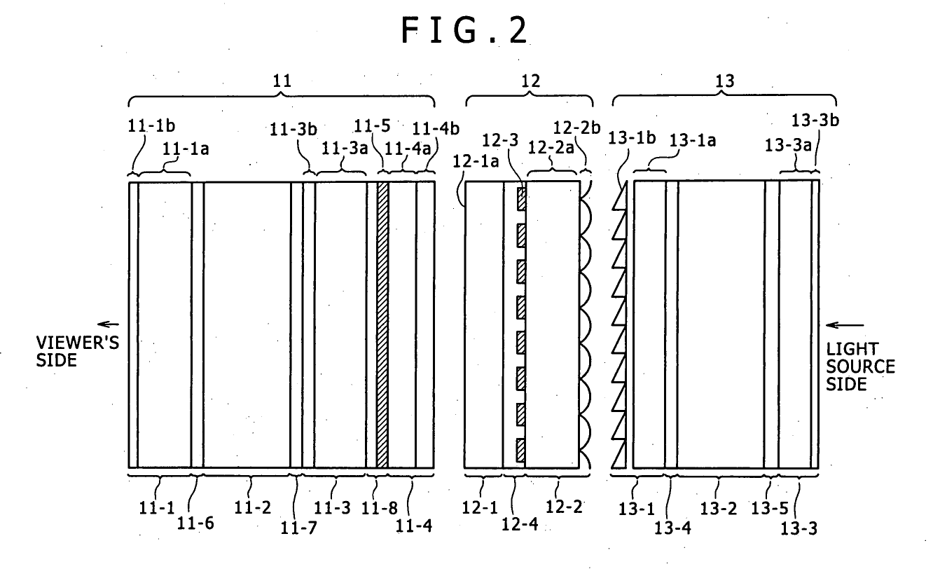

FIG. 2 shows the sectional structure of the transmission type screen 3 as viewed in a horizontal direction. The transmission type screen 3 has a three-layer structure in which a horizontal lenticular lens system 11 (the first layer), a vertical lenticular lens system 12 (the second layer), and a Fresnel lens 13 (the third layer) disposed in this order as viewed from the viewer's side (the left side in the figure).

In the horizontal lenticular lens system 11, a glass substrate 11-2 about 3 mm thick is used as a substrate. An anti-glare (AG) sheet 11-1 is laminated by an adhesive 11-6 onto the surface on the viewer's side of the glass substrate 11-2. The anti-glare sheet 11-1 has a structure in which an anti-glare layer 11-1b for diffusing the incident light is formed on the surface on the viewer's side of a base sheet 11-1a. The anti-glare sheet 11—1 functions to reduce the surface reflection. The anti-glare layer 11-1b is formed, for example, by a method in which a resin layer having minute projections and recesses in its surface is applied to a sheet-like member.

A diffusion sheet 11-3 is laminated by an adhesive 11-7 onto the surface on the side opposite the viewer's side of the glass substrate 11-2 (on the light source side where the video light source 1 and the mirror 2 in FIG. 1 are present). The diffusion sheet 11-3 has a structure in which a diffusion layer 11-3b for diffusing the transmitted light is formed on the surface on the viewer's side of a base sheet 11-3a. The diffusion sheet 11-3 plays the role of enlarging the angle of visibility by diffusing the light being transmitted.

A horizontal lenticular lens sheet 11-4 is laminated by an adhesive 11-8 onto the surface on the light source side of the diffusion sheet 11-3. The horizontal lenticular lens sheet 11-4 has a structure in which a horizontal lenticular lens 11-4b is formed in the surface on the light source side of a base sheet 11-4a. Black stripes (BS) 11-5 are mixedly present in the adhesive 11-8.

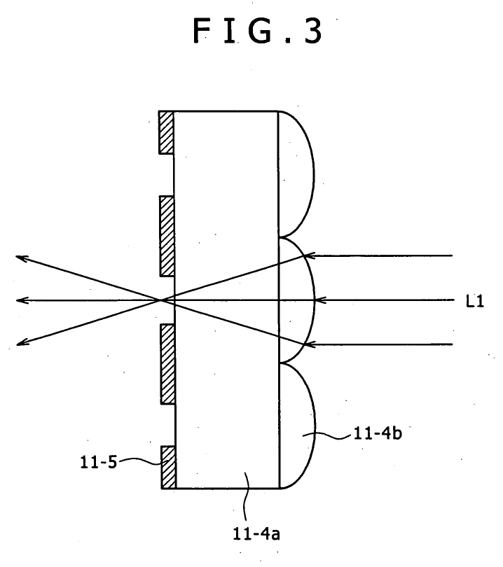

FIG. 3 shows the structure (as viewed in the vertical direction) of the horizontal lenticular lens sheet 11-4 together with the black stripes 11-5, in an enlarged state. The horizontal lenticular lens 11-4b has a structure in which a plurality of lenses fan-shaped in section are arrayed in the vertical direction. The black stripes 11-5 are so provided that the center positions of the individual lenses of the horizontal lenticular lens 11-4b coincide with the positions of the gaps between the black stripes 11-5. The thickness of the base sheet 11-4a is so set that the distance between the horizontal lenticular lens 11-4b and the black stripes 11-5 is equal to the focal distance of the horizontal lenticular lens 11-4b.

This ensures that video light L1 incident as parallel beams on the horizontal lenticular lens system 11 from the light source side is deflected by the horizontal lenticular lens 11-4b, whereby the angle of visibility in the horizontal direction is enlarged. In addition, the black stripes 11-5 has the function of intercepting external light and stray light.

The pitch between the individual lenses of the horizontal lenticular lens 11-4b is designed to be in the range of 50 to 200 μm. The width of each stripe (light intercepting portion) of the black stripes 11-5 is designed to be in the range of 50 to 90% (for example, about 70%) of the pitch between the lenses. The focal distance of the lenticular lens, which has correlations with the thickness of the base sheet and the thickness of the lenticular lens itself, is shorter as the base sheet is thinner and as the lenticular lens is thicker. In the horizontal lenticular lens sheet 11-4, the thickness of the base sheet 11-4a is designed to be in the range of 50 to 100 μm, and this thickness is smaller than the thickness of the base sheet of the vertical lenticular lens system 12 which will be described later. Besides, the thickness of the horizontal lenticular lens 11-4b is designed to be in the range of 20 to 40 μm, and this thickness is greater than the vertical lenticular lens of the vertical lenticular lens system 12 which will be described later. As a result, the focal distance of the horizontal lenticular lens 11-4b is shorter than that of the vertical lenticular lens.

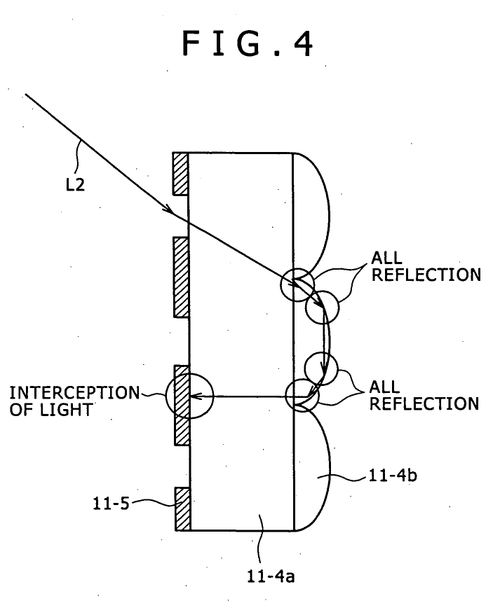

With the focal distance of the horizontal lenticular lens 11-4b thus set short, it is ensured that when external light, for example light from a fluorescent lamp, is incident on the transmission type screen 3 at a certain angle from the viewer's side, as shown in FIG. 4, that portion of the external light L2 which passes through the gaps between the black stripes 11-5 impinges on the side surfaces of the lenses of the horizontal lenticular lens 11-4b, and repeatedly undergoes total reflection on the lens surface of the lenticular lens 11-4b, before impinging on the black stripes 11-5.

In the vertical lenticular lens system 12 shown in FIG. 2, a resin substrate 12-1 about 1.2 mm thick is used as a substrate. The surface 12-1a on the viewer's side of the resin substrate 12-1 faces the horizontal lenticular lens system 11, and an anti-glare treatment has been applied to the surface 12-1a. A vertical lenticular lens sheet 12-2 is laminated by an adhesive 12-4 onto the surface on the light source side of the resin substrate 12-1. The vertical lenticular lens sheet 12-2 has a structure in which a vertical lenticular lens 12-2b is formed on the surface on the light source side of a base sheet 12-2a. Black stripes (BS) 12-3 are mixedly present in the adhesive 12-4.

The structures of the vertical lenticular lens sheet 12-2 and the black stripes 12-3 are the same as the structures of the horizontal lenticular lens sheet 11-4 and the black stripes 11-5 shown in FIG. 3, except that the array directions of the lenses and the stripes are horizontal.

It should be noted here that in the vertical lenticular lens sheet 12-2, the thickness of the base sheet 12-2a is designed to be 2 to 3 times the thickness of the base sheet 11-4a of the horizontal lenticular lens sheet 11-4, and the thickness of the vertical lenticular lens 12-2b is designed to be about one half of the thickness of the horizontal lenticular lens 11-4b. As a result, the focal distance of the vertical lenticular lens 12-2b is longer than that of the horizontal lenticular lens 11-4b, as above-mentioned.

In the Fresnel lens system 13, a glass substrate 13-2 about 3 mm thick is used as a substrate. A Fresnel lens sheet 13-1 is laminated by an adhesive 13-4 onto the surface on the viewer's side of the glass substrate 13-2. The Fresnel lens sheet 13-1 has a structure in which a Fresnel lens 13-1b is formed on the surface on the viewer's side of a base sheet 13-1a.

An anti-glare (AG) sheet 13-3 is laminated by an adhesive 13-5 onto the surface on the light source side of the glass substrate 13-2. The anti-glare sheet 13-3 has a structure in which an anti-glare layer (functioning also as a diffusion layer) 13-3b is formed on the surface on the light source side of a base sheet 13-3a.

The Fresnel lens sheet 13-1 has the function of converting the video light from the mirror 2 in FIG. 1 into parallel beams (converting into beams perpendicular to the screen surface).

The video light projected from the mirror 2 in FIG. 1 on the transmission type screen 3 is converted by the Fresnel lens system 13 into parallel beams, which are enlarged in the angle of visibility in the vertical direction by the vertical lenticular lens system 12, and are then enlarged in the angle of visibility in the horizontal direction by the horizontal lenticular lens system 11, before outgoing toward the viewer(s).

Now, the manner in which the “waviness” due to the light reflected by the vertical lenticular lens system 12 (the second layer) in the transmission type screen 3 (the phenomenon of display irregularities appearing when external light is skewly incident from the viewer's side) is suppressed will be described.

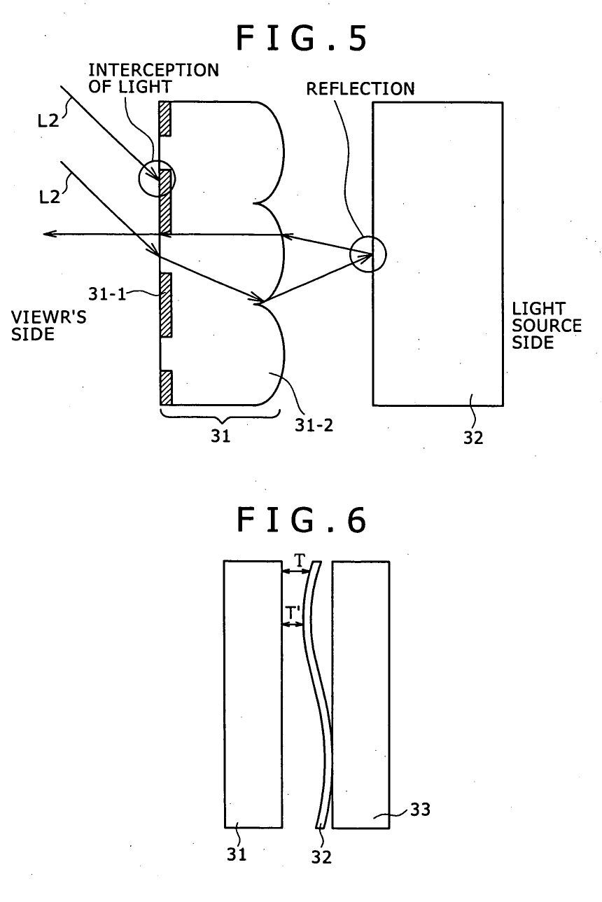

Since the resin substrate 12-1 is used in the vertical lenticular lens system 12, the vertical lenticular lens system 12 is somewhat deflected while being sandwiched between the horizontal lenticular lens system 11 (the first layer) and the Fresnel lens system 13 (the third layer), in the same manner as the second layer 32 shown in FIG. 6. Therefore, as has been described using FIGS. 5 and 6 above, when the external light skewly incident on the transmission type screen 3 from the viewer's side passes through the horizontal lenticular lens system 11 and outgoes to the side of the vertical lenticular lens system 12, the “waviness” due to the light reflected by the vertical lenticular lens system 12 is generated.

However, in the transmission type screen 3, as shown in FIG. 4, the focal distance of the horizontal lenticular lens 11-4b is set short so that the external light having been incident at a certain angle from the viewer's side and having passed through the gaps between the black stripes 11-5 of the horizontal lenticular lens system 11 is reflected on the lens surface of the horizontal lenticular lens 11-4b to impinge upon the black stripes 11-5.

Since the external light having thus impinged on the black stripes 11-5 is intercepted by the black stripes 11-5, as shown in FIG. 4 also, the light does not outgo from the horizontal lenticular lens system 11 toward the side of the vertical lenticular lens system 12 (namely, the light does not outgo from the first layer toward the second layer side).

Therefore, in the transmission type screen 3, the quantity itself of that portion of the external light skewly incident from the viewer's side which passes through the horizontal lenticular lens system 11 and outgoes toward the side of the vertical lenticular lens system 12 can be reduced. This ensures that the “waviness” due to the light reflected by the vertical lenticular lens system 12 can be suppressed effectively.

Besides, in the transmission type screen 3, the horizontal lenticular lens system 11, that is, the horizontal lenticular lens system 11 on the side of the vertical lenticular lens system 12, is disposed as the first layer, and the focal distance of the horizontal lenticular lens 11-4b is set short, as above-mentioned. The lenticular lens has a greater enlarging effect on the angle of visibility as its focal distance is shorter. Here, there are not many cases where the screen is viewed from the skew upper or lower side, but there are many cases where the screen is viewed from the skew left and right sides by a plurality of persons seated or standing side by side in the left-right direction. Therefore, it is demanded that the angle of visibility be more enlarged by the horizontal lenticular lens than by the vertical lenticular lens.

Accordingly, by disposing the horizontal lenticular lens system 11 as the first layer and setting the focal distance of the horizontal lenticular lens 11-4b to be short as above-mentioned, the demand for enlarging the angle of visibility in the horizontal direction can also be met.

Thus, according to the transmission type screen 3, not only the three-layer structure is adopted and the angle of visibility in the vertical direction is enlarged but also the shapes and the positional relationship of the horizontal lenticular lens and the vertical lenticular lens are investigated, whereby it is made possible to effectively suppress the “waviness” due to the light reflected on the second layer and to meet the demand for enlargement of the angle of visibility in the horizontal direction.

In addition, in the transmission type screen 3, an anti-glare treatment has been applied to the surface on the viewer's side of the vertical lenticular lens system 12 (the surface 12-1a on the viewer's side of the resin substrate 12-1), the external light having been incident from the viewer's side and having passed through the horizontal lenticular lens system 11 (the light which has not been reflected by the lens surface of the horizontal lenticular lens 11-4b) is diffusedly reflected by the surface on the viewer's side of the horizontal lenticular lens system 12. Therefore, the quantity of light reflected by the surface on the viewer's side of the vertical lenticular lens system 12 and re-entering the horizontal lenticular lens system 11 is reduced, so that the “waviness” due to the light reflected by the vertical lenticular lens system 12 can be suppressed more.

Furthermore, in the transmission type screen 3, in addition to the suppressing effect on the “waviness”, various effects as described in the following paragraphs (1) to (6) are also obtained.

(1) Since the property for intercepting the external light at the horizontal lenticular lens system 11 is enhanced, when the external light is incident from the viewer's side, those other phenomena than the “waviness” which lead to lowering in picture quality can also be suppressed.

(2) Since the diffusion sheet 11-3 is provided in the horizontal lenticular lens system 11, the angle of visibility in the vertical direction can be enlarged more. In addition, since the diffusion sheet 11-3 is provided on the viewer's side relative to the horizontal lenticular lens sheet 11-4 (hence, on the viewer's side relative to the adhesive 11-7 in which the black stripes 11-5 are mixedly present), the light diffused by the diffusion sheet 11-3 is not intercepted by the black stripes 11-5. Therefore, it is possible to prevent the lowering of the transmittance of light in the transmission type screen 3.

(3) Furthermore, since a sheet having the diffusion layer 11-3b formed on the surface on the viewer's side of the base sheet 11-3a is used as the diffusion sheet 11-3, a certain distance (the distance corresponding to the thickness of the base sheet 11-3a) is secured between the black stripes 11-5 and the diffusion layer 11-3b. If the distance between the black stripes 11-5 and the diffusion layer 11-3b is too short, dispersion is generated between the locations where the luminous flux condensed by the black stripes 11-5 impinges on the particles in the diffusion layer 11-3b and the locations where the impingement does not occur, with the result that glaring of picture (“scintillation”) occurs when a bright picture is displayed. On the other hand, where a certain distance is secured in the above-mentioned manner, the “scintillation” can also be restrained.

(4) Since the anti-glare sheet 11-1 is provided on the surface on the viewer's side of the horizontal lenticular lens system 11, mirroring in the surface of the transmission type screen 3 can be suppressed.

(5) The anti-glare sheet 13-3 is provided on the surface on the light source side of the Fresnel lens system 13. If the light incident on the transmission type screen 3 from the video light source 1 through the mirror 2 is reflected on the surface of the Fresnel lens system 13 and returns to the mirror 2, the returned light is again reflected by the mirror 2 to enter the transmission type screen 3, generating a ghost in the picture being displayed. On the other hand, where the Fresnel lens system 13 is provided with such an anti-glare sheet 13-3, the light is diffusedly reflected on the surface of the Fresnel lens system 13, so that the ghost can also be suppressed.

(6) Since the glass substrates 11-2 and 13-2 are used as substrates in both the horizontal lenticular lens system 11 facing the viewer's side and the Fresnel lens system 13 facing the light source side, the flatness on both sides of the transmission type screen 3 can be kept favorable, so that the picture displayed can be prevented from being distorted due to a worsening of the flatness.

Incidentally, in the above embodiments, the anti-glare sheet 11-1 is laminated on the surface on the viewer's side of the glass substrate 11-2 in the horizontal lenticular lens system 11, as shown in FIG. 2. However, as another embodiment, a structure may be adopted in which an anti-reflection sheet (a sheet for removing reflected light by utilizing a light interference effect) is laminated on the surface on the viewer's side of the glass substrate 11-2.

Besides, in the above embodiments, the horizontal lenticular lens 11-4b is provided as the first layer, and the focal distance of the horizontal lenticular lens 11-4b is so set that the external light having been skewly incident from the viewer's side and having passed through the gaps between the black stripes 11-5 is reflected on the lens surface of the horizontal lenticular lens 11-4b to impinge on the black stripes 11-5. However, according to the incidence angle of the external light pertaining to the “waviness” to be restrained and the degrees of the demand for enlargement of the angles of visibility in the horizontal and vertical directions, a structure may be adopted in which the vertical lenticular lens 12-2b is provided as the first layer (the combination of the black stripes 11-5 and the horizontal lenticular lens sheet 11-4 in FIG. 2 and the combination of the black stripes 12-3 and the vertical lenticular lens sheet 12-2 are interchanged), and the focal distance of the vertical lenticular lens 12-2b is so set that the external light having been skewly incident from the viewer's side and having passed through the gaps between the black stripes 12-3 is reflected on the lens surface of the vertical lenticular lens 12-2b to impinge on the black stripes 12-3.

Besides, in the above embodiments, the present invention is applied to the transmission type screen having the three-layer structure. However, this is not limitative, and, in a transmission type screen having a two-layer structure (a transmission type screen composed of two layers, namely, a first layer having a lenticular lens and having black stripes on the viewer's side relative to the lenticular lens and a second layer adjacent to the first layer), the focal distance of the lenticular lens of the first layer may be so set that the external light having been skewly incident from the viewer's side and having passed through the gaps between the black stripes of the first layer is reflected on the lenticular lens surface of the first layer to impinge on the black stripes.

In addition, while the present invention is applied to a rear projection display in the above embodiments, this is not limitative, and the invention may be applied to transmission type screens for other uses than the rear projection display.

1. A transmission type screen comprising, at least:
a first layer having a lenticular lens and having black stripes on the viewer's side relative to said lenticular lenses; and
a second layer adjacent to said first layer, said two layers being disposed sequentially as viewed from the viewer's side; wherein
the focal distance of said lenticular lens of said first layer is so set that external light having been skewly incident from the viewer's side and having passed through the gaps between said black stripes of said first layer is reflected on the surface of said lenticular lens of said first layer to impinge on said black stripes.

2. The transmission type screen as set forth in claim 1; wherein
said second layer has a lenticular lens in a direction orthogonal to that of said first layer and having black stripes on the viewer's side relative to said lenticular lens, and
a third layer having a Fresnel lens is further disposed on the side of said second layer opposite to the viewer's side.

3. The transmission type screen as set forth in claim 2; wherein
said first layer has a horizontal lenticular lens, and
said second layer has a vertical lenticular lens.

4. The transmission type screen as set forth in claim 1; wherein
said second layer has been anti-glare treated on a surface thereof on the viewer's side.

5. The transmission type screen as set forth in claim 1; wherein
said first layer is provided with a diffusion sheet on the viewer's side relative to said lenticular lens and said black stripes.

6. The transmission type screen as set forth in claim 5; wherein
said diffusion sheet of said first layer is provided by forming a diffusion layer on a surface on the viewer's side of a substrate sheet.

7. The transmission type screen as set forth in claim 1; wherein
said first layer is provided with either one of an anti-glare sheet and an anti-reflection sheet on a surface thereof on the viewer's side.

8. The transmission type screen as set forth in claim 2; wherein
said third layer is provided with an anti-glare sheet on a surface thereof on the side opposite to the viewer's side.

9. The transmission type screen as set forth in claim 2; wherein
said first layer and said third layer each use a glass as a substrate.

10. A rear projection type display system comprising a video light source for emitting video light, and a transmission type screen on which said video light is projected from the rear side; wherein
said transmission type screen comprises, at least:
a first layer having a lenticular lens and having black stripes on the viewer's side relative to said lenticular lens; and
a second layer adjacent to said first layer, said two layers being disposed sequentially as viewed from the viewer's side, and
the focal distance of said lenticular lens of said first layer is so set that external light having been incident skewly from the viewer's side and having passed through gaps between said black stripes of said first layer is reflected on the surface of said lenticular lens of said first layer to impinge on said black stripes.
